(19) United States
(12) Patent Application Publication
(10) Pub. No.: US 2022/0309524 A1
(43) Pub. Date: Sep. 29, 2022

(54) INFORMATION PROCESSING DEVICE, METHOD, AND BEHAVIOR ANALYSIS SYSTEM

(71) Applicant: TOSHIBA TEC KABUSHIKI KAISHA, Tokyo (JP)

(72) Inventor: Yoshiaki MIZUOKA, Kamakura Kanagawa (JP)

(73) Assignee: TOSHIBA TEC KABUSHIKI KAISHA, Tokyo (JP)

(21) Appl. No.: 17/551,542

(22) Filed: Dec. 15, 2021

(30) Foreign Application Priority Data
Mar. 25, 2021 (JP) 2021-051747

(51) Int. Cl. G06Q 30/02; G06N 20/00; G06V 20/52; G06V 40/20

(52) U.S. Cl. CPC G06Q 30/0202; G06N 20/00; G06V 20/52; G06V 40/20

(57) ABSTRACT

An information processing device is configured to acquire purchase presumption information including behavior information indicating a behavior of one or more customers presumed based on sensor information acquired by a sensor installed in a store, first commodity identification information identifying one or more commodities that the one or more customers are presumed to have purchased in presumed transactions based on the behavior information, and first transaction specific information specifying each of the presumed transactions; acquire transaction information related to completed transactions performed within the store via a point of sale system, the transaction information including second commodity identification information identifying one or more commodities purchased in each of the completed transactions and second transaction specific information specifying each of the completed transactions; generate corrected behavior information for a respective transaction based on the transaction information in response to the first commodity identification information and the second commodity identification information not matching.

### CROSS-REFERENCE TO RELATED PATENT APPLICATION

This application is based upon and claims the benefit of priority from Japanese Patent Application No. 2021-051747, filed on Mar. 25, 2021, the entire contents of which are incorporated herein by reference.

### FIELD

Embodiments described herein relate generally to an information processing device, a method, and a behavior analysis system.

### BACKGROUND

In the related art, there have been efforts to detect the behaviors of customers in a retail store or the like. In the store, it is possible to implement various measures for sales expansion based on the detected behaviors of the customers. For example, a store can change the disposition of a commodity based on the detected movement trajectory (movement line) of a customer, or can deliver recommendations and coupons for other commodities related to the commodity upon detection that the customer has taken out the commodity from a commodity display shelf.

In recent years, efforts have been made to presume human behaviors by machine learning. In machine learning, it is important to improve the determination accuracy of a machine learning model. In order to improve the determination accuracy of the machine learning model, training data in which a sensor value is associated with a correct label in an actual environment is required, but the fact is that it takes time and cost to collect the training data.

### DESCRIPTION OF THE DRAWINGS

FIG. 1 is a diagram illustrating an outline of a behavior analysis system including an information processing device according to an embodiment;

FIG. 2 is a block diagram illustrating a hardware configuration of the information processing device;

FIG. 3 is a diagram illustrating a data structure of a purchase presumption information file stored in a memory unit of the information processing device;

FIG. 4 is a diagram illustrating a data structure of a presumption target data file stored in the memory unit of the information processing device;

FIG. 5 is a diagram illustrating a data structure of a transaction information file stored in the memory unit of the information processing device;

FIG. 6 is a diagram illustrating a data structure of a corrected data file stored in the memory unit of the information processing device;

FIG. 7 is a block diagram illustrating a functional configuration of a control unit in the information processing device;

FIG. 8 is a flowchart illustrating a processing flow by the control unit of the information processing device of the embodiment; and

FIG. 9 is a diagram illustrating a correction screen of behavior information in the information processing device.

### DETAILED DESCRIPTION

An object to be solved by the exemplary embodiment is to provide an information processing device, a method, and a behavior analysis system capable of easily improving the determination accuracy of a machine learning model that presumes the behavior of a customer in a store.

In general, according to one embodiment, an information processing device includes a purchase presumption information acquisition unit that acquires purchase presumption information in which behavior information indicating a behavior of a customer presumed based on sensor information of a sensor installed in a store, commodity identification information identifying a commodity that a customer is presumed to have purchased in one transaction based on the behavior information, and transaction specific information specifying the one transaction are associated with each other, a transaction information acquisition unit that acquires transaction information that is information related to the transaction of the store, in which the commodity identification information of a commodity traded in one transaction is associated with the transaction specific information, a comparison unit that compares the commodity identification information included in the purchase presumption information with the commodity identification information included in the transaction information with respect to one transaction specified by the transaction specific information, a correction unit that corrects the behavior information based on the transaction information if the commodity identification information included in the purchase presumption information and the commodity identification information included in the transaction information do not match as a result of the comparison by the comparison unit, and an output unit that outputs the behavior information corrected by the correction unit.

Hereinafter, an information processing device, a method, and a behavior analysis system of an embodiment will be described with reference to the drawings. The exemplary embodiment is not limited by the embodiment described below. For example, in the embodiment described below, an example of applying the behavior analysis system to a supermarket will be described, but the behavior analysis system can be widely applied to various stores selling commodities.

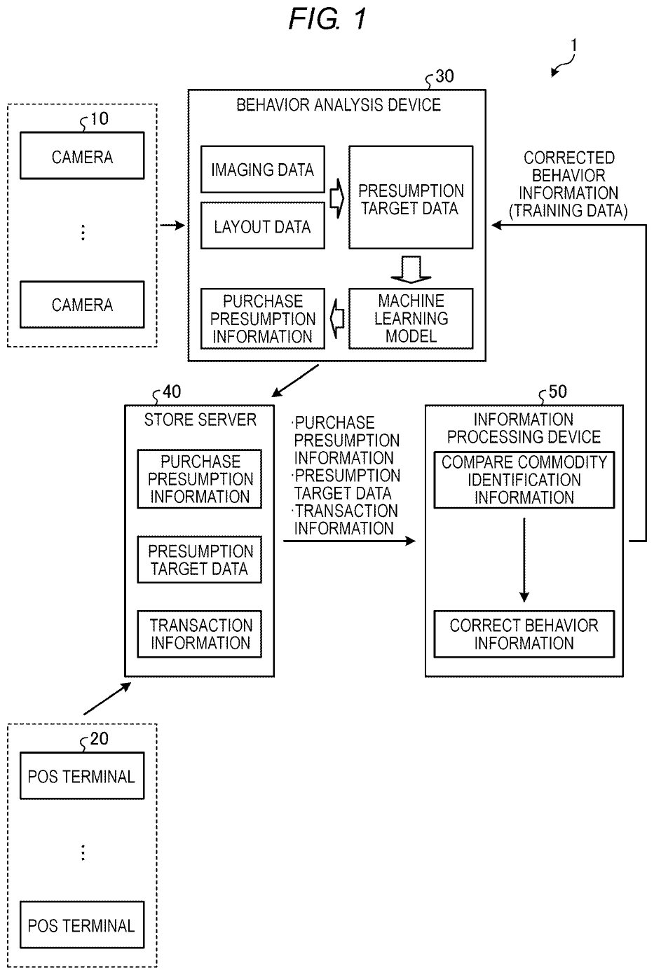

FIG. 1 is a diagram illustrating an outline of the behavior analysis system including the information processing device. A behavior analysis system 1 of the present embodiment is applied to a supermarket (hereinafter, also referred to as a store) that sells groceries, daily necessities, and the like. The behavior analysis system 1 includes a plurality of cameras 10, a plurality of point of sales (POS) terminals 20, a behavior analysis device 30, a store server 40, and an information processing device 50. The plurality of cameras 10, the plurality of POS terminals 20, the behavior analysis device 30, the store server 40, and the information processing device 50 are connected to each other so as to be able to communicate with each other via a network such as a local area network (LAN).

The plurality of cameras 10 are disposed in the sales floor of the store. Each camera 10 is provided corresponding to each commodity display shelf disposed on the sales floor, and can capture an image of a customer's movement or the like on the corresponding commodity display shelf. Each camera 10 outputs the captured imaging data to the behavior analysis device 30 at any time. The imaging data is associated with the imaging data captured by the camera 10, the information indicating the time when the imaging data is captured, and the information specifying the camera that images. The camera 10 is an example of a sensor installed in the store. The imaging data output by the camera 10 is an example of sensor information.

The plurality of POS terminals 20 are provided at the checkout location of the store's sales floor. The POS terminal 20 registers commodity information of a commodity purchased by the customer (hereinafter, also referred to as commodity registration), and executes checkout processing for the commodity registered as a commodity. The checkout processing is processing for paying the price of commodities purchased by the customer, and is for example, processing such as calculation of total amount, calculation of change, transmission and reception of information with a settlement server in cashless settlement, and issuance of a receipt. The POS terminal 20 may be a POS terminal operated by a clerk or a self-checkout POS terminal operated by the customer. The POS terminal 20 is an example of a checkout device that executes checkout processing for transactions in the store. The checkout device may be a so-called semi-self-checkout POS checkout device in which commodity registration and checkout processing are performed by separate devices.

The POS terminal 20 outputs transaction information to the store server 40. The transaction information is information in which commodity identification information (for example, commodity code, commodity name, and the like) identifying a commodity traded in one transaction and transaction specific information (for example, payment (checkout) time and POS terminal number, and the like) specifying one transaction are associated with each other. The store server 40 stores the acquired transaction information in a storage unit (not illustrated). The POS terminal 20 may output transaction information to the store server 40 at any time, or may output transaction information periodically (for example, at a predetermined time every day).

The behavior analysis device 30 presumes the behavior of the customer based on the imaging data acquired from the camera 10. For example, the behavior analysis device 30 presumes the behavior of the customer such as a movement of taking out a commodity from a commodity display shelf (hereafter, also referred to as acquisition behavior), a movement of returning a commodity taken out from the commodity display shelf to the commodity display shelf (hereafter, also referred to as return behavior), and a movement of checking out at the POS terminal 20 (hereafter, also referred to as checkout behavior). The behavior of the customer is presumed by using a machine learning model. In addition, the behavior analysis device 30 presumes the commodity purchased by the customer in one transaction based on the presumed behavior of the customer.

Here, the function of the behavior analysis device 30 will be described in detail. The processing executed by the behavior analysis device 30 includes generation of presumption target data, presumption of the behavior of the customer, generation of purchase presumption information, output of information to a system utilizing a presumption result, output of information to the store server 40, and the like. Hereinafter, these processing will be described.

Generation of Presumption Target Data

The presumption target data is data to be input to the machine learning model, and is imaging data generated by image processing based on the imaging data acquired from the camera 10. The behavior analysis device 30 stores layout data of the sales floor of the store. The layout data includes information such as the disposition of commodity display shelves and information in which each commodity display shelf is associated with the commodities displayed on the display shelf. The behavior analysis device 30 generates presumption target data based on the imaging data and layout data acquired from the camera 10 as preprocessing for inputting data into the machine learning model.

The behavior analysis device 30 extracts feature information (for example, a face image) of a specific customer from the imaging data acquired from the camera 10, and arranges the imaging data including the feature information in chronological order. In addition, the behavior analysis device 30 extracts imaging data indicating one movement from the customer reaching for a commodity display shelf to returning from the imaging data including the feature information. Information (e.g., camera number) specifying the captured camera 10 is associated with each imaging data. Since each camera 10 corresponds to each commodity display shelf, and each commodity display shelf is associated with the commodity displayed on the commodity display shelf by the layout data, the behavior analysis device 30 can recognize which commodity the customer has reached for, as illustrated in the imaging data. In addition, the behavior analysis device 30 extracts imaging data from when a specified customer stops at the POS terminal 20 until he or she leaves. It is also possible to extract the above-mentioned imaging data by a machine learning model. By extracting imaging data in this way, presumption target data is generated.

The imaging data illustrating one movement from when a specific customer reaches for a commodity display shelf to when he or she returns, and the imaging data from when the specific customer stops at the POS terminal 20 to when he or she leaves, which are extracted by behavior analysis device 30, are examples of presumption target data. By arranging these presumption target data in chronological order, data for presuming the behavior of a specific customer in one transaction is generated.

Presumption of Customer Behavior

Customer behavior presumption is performed by using a machine learning model. A machine learning model is generated based on training data including imaging data and a correct label for the behavior included in the imaging data. In addition, the machine learning model trains by using the behavior information acquired from the information processing device 50 as training data, and the parameters of the machine learning model are adjusted. As a result, the determination accuracy of the machine learning model can be improved. The behavior information acquired from the information processing device 50 will be described later.

Presumption target data is input to the machine learning model. In the machine learning model, for example, when imaging data indicating one movement from when a specific customer reaches for a commodity display shelf to when he or she returns is input, it is determined whether the behavior of the customer included in the imaging data is an acquisition behavior or a return behavior. The machine learning model extracts the behavior of the customer, and presumes that the behavior has been performed if a probability value at which the extracted behavior is determined to be performed is equal to or higher than a predetermined value (for example, 70%). Presumption target data related to the behavior of the customer during one transaction is input to the machine learning model, and the machine learning model extracts the behavior included in each presumption target data and determines whether or not the extracted behavior is performed. For example, the machine learning model determines whether or not behavior such as acquisition behavior, return behavior, or checkout behavior of the customer has been performed during one transaction. The machine learning model outputs information (hereinafter, also referred to as behavior information) indicating the behavior of one extracted transaction. The behavior information includes, for example, the name of behavior such as acquisition, return, and checkout, a determination result of whether or not the behavior has been performed, and a time when the behavior is presumed to have been performed. The same determination ID is assigned to the presumption target data input to the machine learning model and the behavior information output from the machine learning model, and the two are associated with each other.

Generation of Purchase Presumption Information

The behavior analysis device 30 generates purchase presumption information based on each behavior information output from the machine learning model at any time. The purchase presumption information includes information in which behavior information indicating the behavior of one transaction output by the machine learning model, commodity identification information identifying a commodity that the customer is presumed to have purchased in one transaction based on the behavior information, and transaction specific information specifying the one transaction are associated with each other. In the present embodiment, the purchase presumption information further includes information indicating the quantity for each commodity presumed to have been purchased in one transaction. The commodity identification information is, for example, a commodity name or a commodity code. In the present embodiment, the transaction specific information is composed of the time when the customer is presumed to have checked out at the POS terminal 20 and POS terminal number. The time when the customer is presumed to have checked out at the POS terminal 20 may be set as, for example, the time of presumed behavior of receiving a receipt during the checkout. Further, the time when the customer stops at the POS terminal 20 and the time when the customer leaves the POS terminal 20 after completing the settlement may be treated as a set as the checkout time.

Output of Information to System Utilizing Presumption Result

The behavior analysis device 30 outputs the behavior information output by the machine learning model or the purchase presumption information presumed based on the behavior information to an external system. The external system loads various services based on the information acquired from the behavior analysis device 30. An example of the external system is a coupon issuing system or the like. If a coupon issuing system acquires the behavior information indicating that the customer has taken out a certain commodity from a commodity display shelf from the behavior analysis device 30, it is possible to perform processing such as distributing the coupons for commodities related to the commodity to the customer's mobile terminal. The external system is not limited to the coupon issuing system.

Output of Information to Store Server 40

The behavior analysis device 30 outputs the generated presumption target data and purchase presumption information to the store server 40 at any time. Determination ID is also included in the presumption target data and purchase presumption target information. The store server 40 stores the acquired presumption target data and purchase presumption information in a storage unit (not illustrated). In the present embodiment, the presumption target data and purchase presumption target information output by the behavior analysis device 30 to the store server 40 include those related to behaviors that the machine learning model determines to have been performed by the customer, as well as behaviors that have been extracted but not determined to have been performed by the customer. However, the presumption target data and the purchase presumption target information output by the behavior analysis device 30 to the store server 40 may be only those related to the behavior determined to be performed by the customer in the machine learning model.

Next, the store server 40 will be described. The store server 40 acquires transaction information from each POS terminal 20 and stores the transaction information. In addition, the store server 40 acquires purchase presumption information and presumption target data from the behavior analysis device 30, and stores these purchase presumption information and presumption target data. Then, the store server 40 outputs transaction information, presumption target data, and purchase presumption information for a predetermined period (for example, one month) to the information processing device 50 in response to an output request from the information processing device 50, for example. The store server 40 may output transaction information, presumption target data, and purchase presumption information for a predetermined period to the information processing device 50, not in response to the output request from the information processing device 50, but at a preset timing.

Further, the store server 40 stores a commodity master in which a commodity code and commodity information (commodity name, price, and the like) are associated with each other for the commodities handled in the store. Since the commodities handled in the store change daily, the commodity master is updated as appropriate. The store server 40 transmits the commodity master to each POS terminal 20.

The information processing device 50 provides the behavior analysis device 30 with training data for training the machine learning model of the behavior analysis device 30. The information processing device 50 compares the purchased commodity in one transaction presumed by the behavior analysis device 30 with the purchased commodity included in the transaction information actually traded in the one transaction, and corrects the behavior information presumed by the behavior analysis device 30 if the two are different. For example, the information processing device 50 corrects the behavior information by using the transaction information actually traded as correct data. Then, the information processing device 50 outputs the corrected behavior information to the behavior analysis device 30. The behavior analysis device 30 can improve the determination accuracy of the machine learning model by training the machine learning model using the behavior information acquired from the information processing device 50 as training data. Since the information processing device 50 functions as described above, the information processing device 50 can also be referred to a training data generation device.

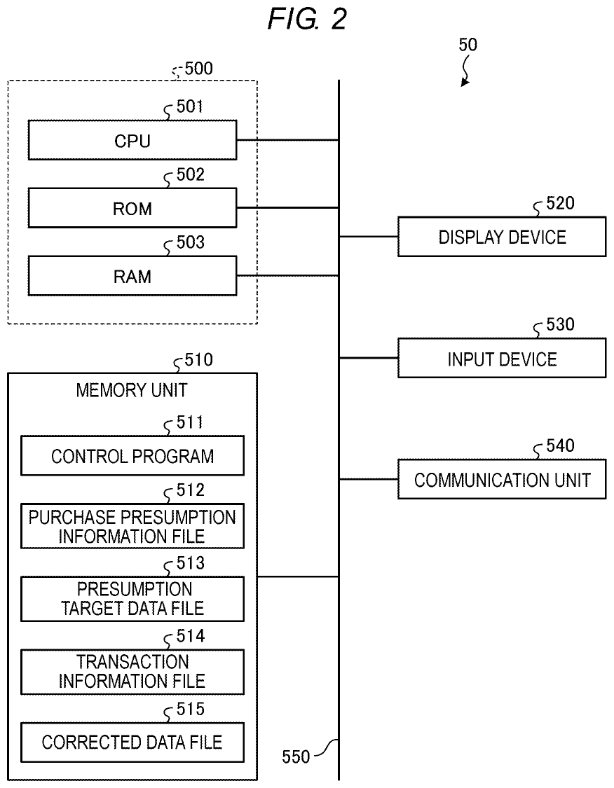

Next, the hardware configuration of the information processing device 50 will be described. FIG. 2 is a block diagram illustrating a hardware configuration of the information processing device 50. The information processing device 50 includes a control unit 500 (a controller, a control system), a memory unit 510 (a memory), a display device 520 (a display), an input device 530, and a communication unit 540 (a communications interface). The control unit 500, the memory unit 510, the display device 520, the input device 530, and the communication unit 540 are connected to each other via a bus 550 or the like.

The control unit 500 is composed of a computer including a processing circuit or central processing unit (CPU) 501, a read only memory (ROM) 502, and a random access memory (RAM) 503. The CPU 501, ROM 502, and RAM 503 are connected to each other via the bus 550.

The CPU 501 controls the overall operation of the information processing device 50. The ROM 502 stores various programs such as a program used to drive the CPU 501 and various data. The RAM 503 is used as a work area of the CPU 501, and loads various programs and various data stored in the ROM 502 and the memory unit 510. The control unit 500 executes various control processing of the information processing device 50 by the CPU 501 operating according to a control program stored in the ROM 502 or the memory unit 510 and loaded in the RAM 503.

The memory unit 510 is composed of a storage medium such as a hard disk drive (HDD) or a flash memory, and maintains the stored contents therein even if the power is cut off. The memory unit 510 stores a control program 511, a purchase presumption information file 512, a presumption target data file 513, a transaction information file 514, and a corrected data file 515. The purchase presumption information file 512, the presumption target data file 513, the transaction information file 514, and the corrected data file 515 may be stored in an external memory.

The control program 511 is a program or the like that causes the information processing device 50 to function as a generation device of training data that is provided to the machine learning model of the behavior analysis device 30.

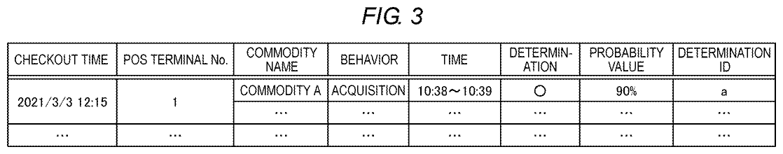

The purchase presumption information file 512 is a file that manages the purchase presumption information acquired from the store server 40. The purchase presumption information is data for each transaction and is transmitted from the behavior analysis device 30 to the store server 40 at any time. For example, the information processing device 50 acquires purchase presumption information for one month from the store server 40 once a month. Each piece of information included in the purchase presumption information is the information presumed by the behavior analysis device 30. FIG. 3 is a diagram illustrating a data structure of the purchase presumption information file 512. Each data registered in the purchase presumption information file 512 is associated with the information indicating checkout time, POS terminal number, commodity name, behavior, time, determination, a probability value, and determination ID.

In the item of checkout time, information indicating the time when the customer is presumed to have checked out in one transaction is registered. That is, the information registered at the checkout time is information indicating the checkout time presumed by the behavior analysis device 30 based on the imaging data from the camera 10. In the item of POS terminal number, a unique number identifying the POS terminal 20 at which the customer is presumed to have been checked out is registered. By specifying the checkout time and the number of the POS terminal 20 in which a transaction has been settled, it is possible to specify one transaction. In other words, the combination of the checkout time and the POS terminal number is an example of transaction specific information. If there is one checkout machine such as the POS terminal 20 installed in the store, one transaction can be specified only by the checkout time, and therefore only the checkout time is the transaction specific information.

In the item of commodity name, information indicating the name of the commodity presumed to have been purchased by the customer is registered. The information registered in the item of commodity name is an example of the commodity identification information. The purchase presumption information file 512 may register a commodity code as the commodity identification information. In the item of behavior, information indicating the behavior content of the customer extracted by the behavior analysis device 30 is registered. The information registered in the item of behavior name is an example of behavior information. In the item of time, information indicating the start time and end time of the imaging data used for presuming a behavior is registered. In the item of time, for example, only the start time or the end time of the imaging data used for presuming a behavior may be registered.

In the item of determination, information indicating the determination result of whether the behavior content of the customer extracted by the behavior analysis device 30 is correct or incorrect is registered. If “O” is registered in the item of determination, it is determined that the corresponding behavior has been performed. In the item of a probability value, information indicating the probability of determining the behavior extracted by the machine learning model of the behavior analysis device 30 as correct is registered. In the example illustrated in FIG. 3, in one transaction checked out at the POS terminal 20 with POS terminal number 1 at 12:15 on Mar. 3, 2021, the probability that a commodity A was taken out with the behavior at 10:38 to 10:39 is 90%, and the behavior analysis device determined that the commodity A was taken out and purchased. In the item of determination ID, information for associating the input (presumed target data) and the output (behavior information) in the machine learning model of the behavior analysis device 30 is registered.

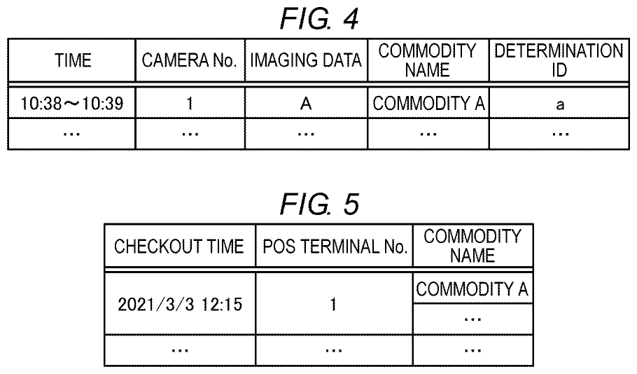

The presumption target data file 513 is a file that manages the presumption target data acquired from the store server 40. The presumption target data is imaging data for each individual behavior generated by the behavior analysis device 30, and is transmitted from the behavior analysis device 30 to the store server 40 at any time. The information processing device 50 acquires the presumption target data from the store server 40 at the timing of acquiring the purchase presumption information. FIG. 4 is a diagram illustrating a data structure of the presumption target data file 513. In each data registered in the presumption target data file 513, information indicating time, camera number, imaging data, commodity name, and determination ID are associated with each other.

In the item of time, information indicating the start time and end time of the imaging data used for presuming a behavior is registered. In the item of camera number, a unique number identifying the camera that has captured the imaging data is registered. In the item of imaging data, the imaging data captured by the camera of the corresponding time and camera number is registered. In the item of commodity name, information indicating the name of the commodity to be imaged of the corresponding imaging data, in other words, the commodity to be the target of the behavior extracted by the behavior analysis device 30, is registered. As described above, the information for associating the input (presumption target data) and the output (behavior information) in the machine learning model of the behavior analysis device 30 is registered in the item of determination ID.

The transaction information file 514 is a file that manages transaction information acquired from the store server 40. The transaction information is transmitted from each POS terminal 20 to the store server 40 at any time. The information processing device 50 acquires transaction information from the store server 40 at the timing of acquiring purchase presumption information. FIG. 5 is a diagram illustrating a data structure of the transaction information file 514. In each data registered in the transaction information file 514, information indicating checkout time, POS terminal number, and commodity name is associated with each other.

The information indicating the checkout time recorded by the POS terminal 20 is registered in the item of checkout time. A unique number identifying the POS terminal 20 is registered in the item of POS terminal number. By specifying the checkout time and the number of the POS terminal 20 in which a transaction has been settled, it is possible to specify one transaction. As described above, the combination of the checkout time and the POS terminal number is an example of transaction specific information.

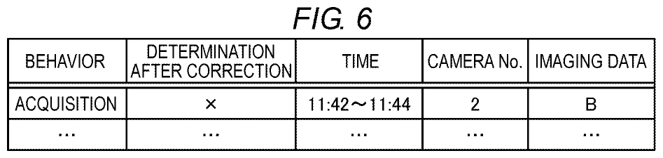

The corrected data file 515 is a file that manages corrected data to be output as training data to the behavior analysis device 30. The corrected data is generated by the information processing device 50. The corrected data is generated based on the comparison between the purchased commodity presumed based on the output of the machine learning model of the behavior analysis device 30 and the purchased commodity based on the transaction information checked out at the POS terminal 20 in one transaction. FIG. 6 is a diagram illustrating a data structure of the corrected data file 515. Each data registered in the corrected data file 515 is associated with information indicating a behavior, determination after correction, time, camera number, and imaging data.

In the item of behavior, information indicating the behavior content of the customer extracted by the behavior analysis device 30 is registered as in the item of behavior in the purchase presumption information file 512. The determination result corrected by the information processing device 50 is registered in the item of determination after correction. In the example of FIG. 6, since “X” is registered in the item of determination after correction, there is an error in the determination result “O” of the acquisition behavior by the machine learning model and the determination result is corrected to “X”. The information registered in the item of behavior and the information registered in the item of determination after correction are examples of the corrected behavior information.

In the item of time, information indicating the start time and end time of the imaging data used for presuming a behavior is registered. In the item of camera number, a unique number identifying the camera that has captured the imaging data is registered. In the item of imaging data, the imaging data captured by the camera of the corresponding time and camera number is registered. It can be said that the corrected behavior information (information registered in each item of behavior and determination after correction) and the presumption target data (information registered in each item of time, camera number, and imaging data) corresponding to the behavior information are registered in the corrected data file 515.

Description is continued by returning to FIG. 2. The display device 520 displays various information such as a correction screen described later. The input device 530 inputs information to the control unit 500, and includes a touch panel provided on the surface of the display device 520, a keyboard, and the like. The communication unit 540 is an interface for communicating with an external device such as the behavior analysis device 30 and the store server 40. By connecting the control unit 500 to the external device via the communication unit 540, information (data) can be transmitted to and received from the external device.

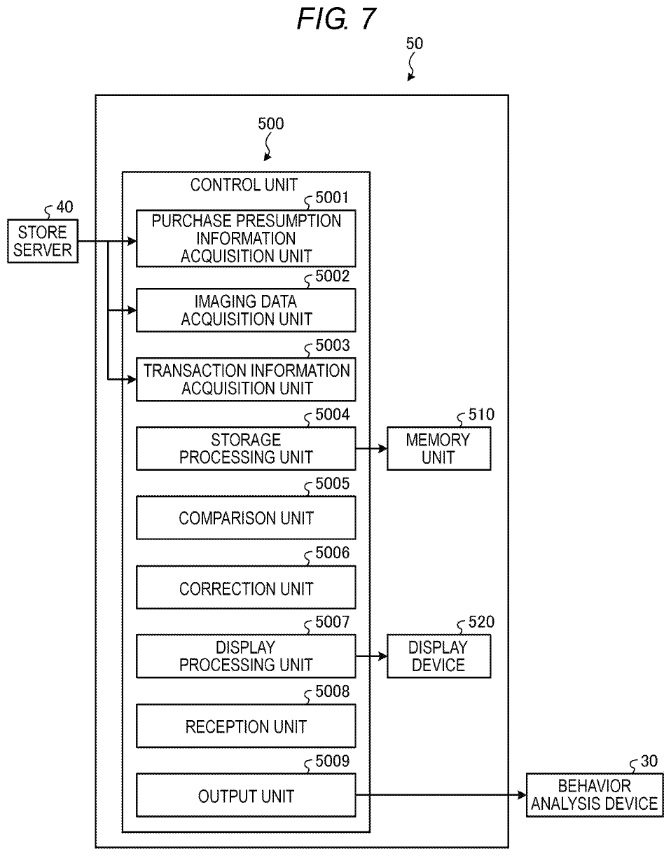

Next, the functional configuration of the information processing device 50 will be described. FIG. 7 is a block diagram illustrating a functional configuration of the control unit 500 of the information processing device 50. If the CPU 501 operates according to the control program stored in the ROM 502 or the memory unit 510, the control unit 500 functions as a purchase presumption information acquisition unit 5001, an imaging data acquisition unit 5002, a transaction information acquisition unit 5003, a storage processing unit 5004, a comparison unit 5005, a correction unit 5006, a display processing unit 5007, a reception unit 5008, and an output unit 5009. Each of these functions may be configured by hardware such as a dedicated circuit.

The purchase presumption information acquisition unit 5001 acquires purchase presumption information in which behavior information indicating the behavior of the customer presumed based on sensor information of a sensor installed in a store, commodity identification information identifying a commodity that the customer is presumed to have purchased in one transaction based on the behavior information, and transaction specific information specifying the one transaction are associated with each other. The behavior information is, for example, information indicating the behavior of the customer presumed by the machine learning model of the behavior analysis device 30 based on the imaging data of the camera 10. The commodity identification information is, for example, the name of a commodity presumed to have been purchased by the customer in one transaction based on the presumption result of the machine learning model of the behavior analysis device 30. The transaction specific information is, for example, the time of settlement presumed by the behavior analysis device 30 and the POS terminal number. The purchase presumption information acquisition unit 5001 acquires the purchase presumption information from the store server 40.

The imaging data acquisition unit 5002 acquires the imaging data of the camera 10. Specifically, the imaging data acquisition unit 5002 acquires the presumption target data generated by the behavior analysis device 30 from the store server 40. That is, the imaging data acquisition unit 5002 acquires the imaging data input to the machine learning model of the behavior analysis device 30 from the store server 40.

The transaction information acquisition unit 5003 acquires transaction information in which the commodity identification information of the commodity traded in one transaction and the transaction specific information are associated with each other, which is the information related to the transaction of the store. The commodity identification information is, for example, a commodity name indicating the name of a commodity. The transaction specific information is, for example, the checkout time recorded on the POS terminal 20 and the number of the POS terminal 20. The transaction information acquisition unit 5003 acquires transaction information from the store server 40.

The purchase presumption information acquisition unit 5001, the imaging data acquisition unit 5002, and the transaction information acquisition unit 5003 respectively acquire information from the store server 40, for example, once a month at the same timing. The purchase presumption information acquisition unit 5001, the imaging data acquisition unit 5002, and the transaction information acquisition unit 5003 may actively acquire information by outputting an output request to the store server 40, or may passively acquire information after waiting for the output of the store server 40.

The storage processing unit 5004 stores the information acquired by the purchase presumption information acquisition unit 5001, the imaging data acquisition unit 5002, and the transaction information acquisition unit 5003 in the memory unit 510. Specifically, the storage processing unit 5004 registers the purchase presumption information acquired by the purchase presumption information acquisition unit 5001 in the purchase presumption information file 512. Further, the storage processing unit 5004 registers the presumption target data acquired by the imaging data acquisition unit 5002 in the presumption target data file 513. Similarly, the storage processing unit 5004 registers the transaction information acquired by the transaction information acquisition unit 5003 in the transaction information file 514. Further, the storage processing unit 5004 registers the behavior information corrected by the correction unit 5006 in the corrected data file 515.

The comparison unit 5005 compares the commodity identification information included in the purchase presumption information with the commodity identification information included in the transaction information for one transaction specified by the transaction specific information. For example, the comparison unit 5005 compares the commodity name and quantity of the commodity presumed to have been purchased by the customer by the behavior analysis device 30 with the commodity name and quantity of the commodity actually checked out by the customer at the POS terminal 20 for one transaction.

If the commodity identification information included in the purchase presumption information and the commodity identification information included in the transaction information do not match as a result of the comparison by the comparison unit 5005, the correction unit 5006 corrects the behavior information based on the transaction information. Specifically, as a result of comparison by the comparison unit 5005, if the commodity name and quantity of the commodity presumed to have been purchased by the customer by the behavior analysis device 30 and the commodity name and quantity of the commodity actually purchased by the customer at the POS terminal 20 do not match, the correction unit 5006 corrects the behavior information based on the transaction information of the POS terminal 20.

For example, based on the presumption that the customer has acquired a certain commodity by the machine learning model in one specific transaction, the behavior analysis device 30 presumed that the commodity has been purchased, but the commodity may not be included in the transaction information output from the POS terminal 20. In this case, the correction unit 5006 corrects the behavior information indicating that the commodity has been acquired by the machine learning model, based on the correction input which is input to the reception unit 5008 after an operator confirms the imaging data. The correction unit 5006 may automatically correct the behavior information. For example, in the above example, the correction unit 5006 may determine that the transaction information is correct data and the presumption by the machine learning model that the commodity has been acquired is incorrect, and correct the behavior information indicating the acquisition without confirmation of the operator.

The display processing unit 5007 displays imaging data acquired by the imaging data acquisition unit 5002, behavior information and commodity identification information acquired by the purchase presumption information acquisition unit 5001, and a correction screen for displaying commodity identification information acquired by the transaction information acquisition unit 5003 on the display device 520 for one transaction specified by the transaction specific information. Specifically, the display processing unit 5007 displays the presumption target data related to one transaction, the behavior information indicating the presumed behavior of the customer, and the commodity name on the display device 520, which are the information output from the behavior analysis device 30. The display processing unit 5007 also displays the quantity of the commodity identified by the commodity name. At the same time, the display processing unit 5007 displays the commodity name and the quantity of the commodity purchased by the customer in the one transaction on the display device 520, which are the information output from the POS terminal 20.

The reception unit 5008 accepts the correction input of the behavior information. For example, the operator operating the information processing device 50 accepts the correction input of the behavior information to be input to the input device 530 while looking at the confirmation screen displayed on the display device 520.

The output unit 5009 outputs the behavior information corrected by the correction unit 5006. Specifically, the output unit 5009 outputs the behavior information corrected by the correction unit 5006 to the behavior analysis device 30. The corrected behavior information is used as training data for the machine learning model of the behavior analysis device 30.

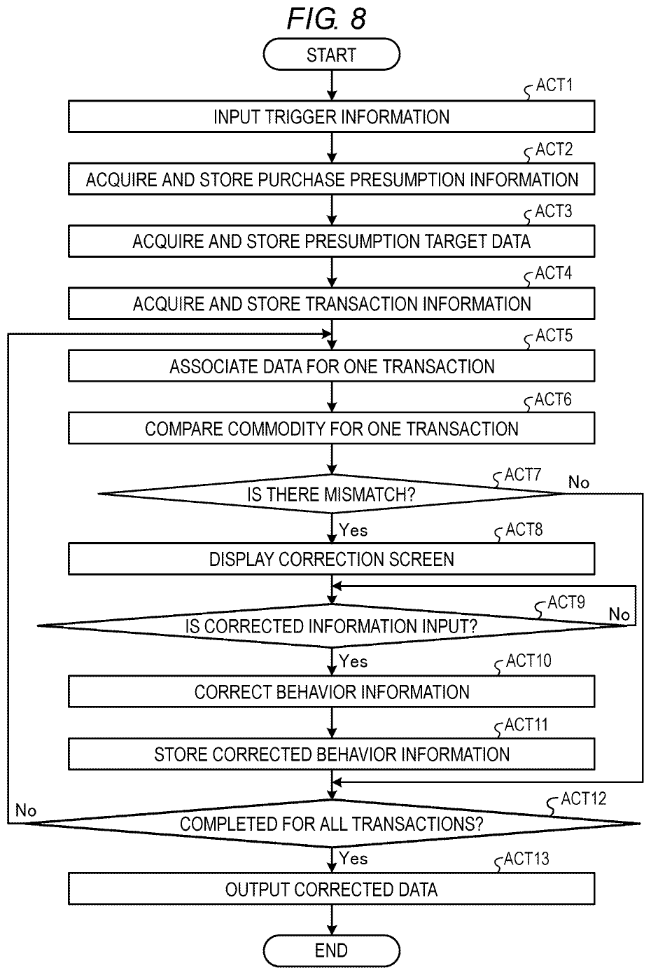

Next, the processing of the control unit 500 of the information processing device 50 will be described. FIG. 8 is a flowchart illustrating a flow of processing by the control unit 500 of the information processing device 50.

First, trigger information is input to the control unit 500 (ACT 1). The trigger information is information instructing the start of generation of training data of the machine learning model, and may be input by the operator's operation, or may be input from the store server 40 at a preset date and time. If the trigger information is input, the purchase presumption information acquisition unit 5001 acquires the purchase presumption information from the store server 40, and the storage processing unit 5004 stores the purchase presumption information in the purchase presumption information file 512 (ACT 2).

At the same time, the imaging data acquisition unit 5002 acquires the presumption target data from the store server 40, and the storage processing unit 5004 stores the presumption target data in the presumption target data file 513 (ACT 3). Further, the transaction information acquisition unit 5003 acquires the transaction information from the store server 40, and the storage processing unit 5004 stores the transaction information in the transaction information file 514 (ACT 4). The information acquired by the purchase presumption information acquisition unit 5001, the imaging data acquisition unit 5002, and the transaction information acquisition unit 5003 is data of the same period (for example, the same one month).

Next, the comparison unit 5005 extracts the purchase presumption information, the presumption target data, and the transaction information for one transaction from the information stored in the purchase presumption information file 512, the presumption target data file 513, and the transaction information file 514 and associates with each other (ACT 5). The transaction specific information (checkout time and POS terminal number) is used as a key to associate the purchase presumption information with the transaction information (see FIGS. 3 and 5). Since the checkout time included in the purchase presumption information is a presumed time, the checkout time may not match the checkout time included in the transaction information. In this case, the comparison unit 5005 compares the purchase presumption information with the transaction information, and associates the purchase presumption information with the transaction information for the one transaction at the same POS terminal number and the closest checkout time. In addition, the determination ID is used as a key to associate the purchase presumption information with the presumption target data (see FIGS. 3 and 4).

Next, the comparison unit 5005 compares the commodity name and the quantity included in each of the associated purchase presumption information and transaction information (ACT 6). In other words, the comparison unit 5005 compares the commodity presumed to have been purchased by the customer by the behavior analysis device 30 with the commodity actually checked out by the customer at the POS terminal 20.

As a result of the comparison by the comparison unit 5005, the control unit 500 determines whether or not there is a mismatch between the commodity name and quantity of the commodity included in the purchase presumption information and the commodity name and quantity of the commodity included in the transaction information (ACT 7). If there is a mismatch, that is, if there is even one commodity name that does not match (Yes in ACT 7), the display processing unit 5007 displays a correction screen 521 on the display device 520 (ACT 8).

The control unit 500 determines whether or not the reception unit 5008 has accepted the correction input of the behavior information (ACT 9). The details of the correction screen and the correction input of the behavior information will be described later. If the correction input is not accepted (No in ACT 9), the control unit 500 returns to the processing in ACT 9. If the correction input is accepted (Yes in ACT 9), the correction unit 5006 corrects the behavior information based on the correction input (ACT 10). For example, the correction unit 5006 corrects the behavior information presumed that the customer has acquired a certain commodity to the behavior information that the customer has not acquired the commodity.

Next, the storage processing unit 5004 stores the corrected behavior information in the corrected data file 515 of the memory unit 510 (ACT 11). The control unit 500 determines whether or not the processing of ACT 5 to ACT 11 is completed for all transactions of the acquired information (ACT 12). If the processing is not completed (No in ACT 12), the control unit 500 returns to the processing in ACT 5. If the processing is completed (Yes in ACT 12), the output unit 5009 outputs the corrected data (corrected behavior information stored in the corrected data file 515) to the behavior analysis device 30. Then, the control unit 500 ends the processing. If there is no mismatch in the processing of ACT 7 (No in ACT 7), the control unit 500 skips the processing of ACT 8 to ACT 11 and transitions to the processing of ACT 12.

By the above processing, the behavior information presumed by the machine learning model of the behavior analysis device 30 is corrected based on the transaction information of the POS terminal 20, and the corrected behavior information is output to the behavior analysis device 30 as training data.

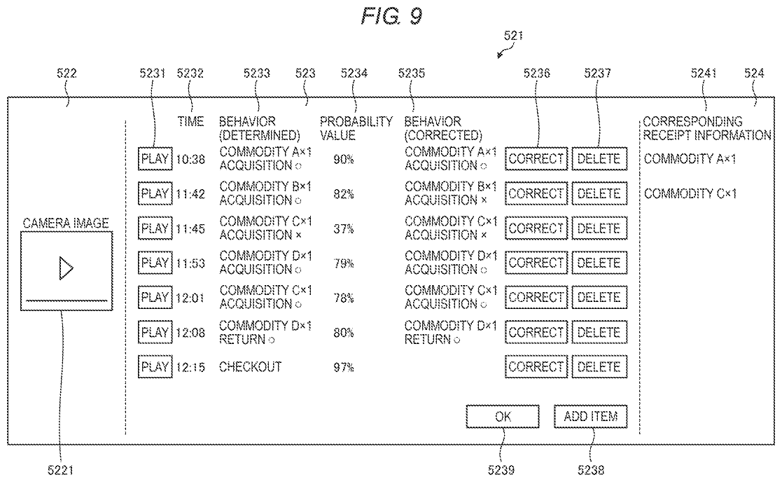

Next, the correction screen and the correction input of the behavior information will be described. FIG. 9 is a diagram illustrating an example of the correction screen 521. The correction screen 521 includes an imaging data display area 522, a purchase presumption information display area 523, and a transaction information display area 524.

A display frame 5221 is formed in the imaging data display area 522. The display frame 5221 displays the presumption target data input to the machine learning model of the behavior analysis device 30. The presumption target data is a camera image, that is, imaging data captured by the camera 10.

In the purchase presumption information display area 523, a play button 5231, a time display section 5232, a determined behavior information display section 5233, a probability value display section 5234, a corrected behavior information display section 5235, a correction button 5236, a delete button 5237, an item addition button 5238, and an OK button 5239 are displayed. The play button 5231, the time display section 5232, the determined behavior information display section 5233, the probability value display section 5234, the corrected behavior information display section 5235, the correction button 5236, and the delete button 5237 are associated with each presumption target data, in other words, with one behavior. Information for one transaction is displayed in the purchase presumption information display area 523.

The play button 5231 is a button for playing back the presumption target data input to the machine learning model of the behavior analysis device 30. The time display section 5232 displays the imaging start time of the presumption target data. The determined behavior information display section 5233 displays the behavior information and the determination result corresponding to the presumption target data. Specifically, the determined behavior information display section 5233 displays the commodities and behaviors extracted by the machine learning model of the behavior analysis device 30 from the presumption target data, and the determination results of the behaviors by the machine learning model. In the example of the first row of FIG. 9, the machine learning model of the behavior analysis device 30 extracts that the customer has acquired one commodity A from the commodity display shelf, and determines that the extracted behavior is correct.

The probability value display section 5234 displays the probability value at which it is determined that the behavior extracted by the machine learning model of the behavior analysis device 30 has been executed. The corrected behavior information display section 5235 displays the behavior information corrected from the determination result, and the determination result. The corrected behavior information display section 5235 displays the same as the determined behavior information display section 5233 for the behavior information whose determination result is not corrected. In addition, the corrected behavior information display section 5235 highlights the behavior information corrected from the determination result, and the determination result. Highlighting is done by changing the color of the characters and the thickness of the characters from other displays. In the example of the second row of FIG. 9, it is assumed that the result of determining that the behavior of the customer acquiring a commodity B from the commodity display shelf by the machine learning model of the behavior analysis device 30 is correct (performed) is incorrect, and it is corrected that the commodity B has not been acquired from the commodity display shelf.

The correction button 5236 is a button for correcting the behavior information. If the correction button 5236 is operated, for example, a dialog in which the corrected contents can be input is displayed in a pop-up. The delete button 5237 is a button for deleting the corresponding row displayed in the purchase presumption information display area 523, that is, the play button 5231, the time display section 5232, the determined behavior information display section 5233, the probability value display section 5234, the corrected behavior information display section 5235, and the correction button 5236 corresponding to the delete button 5237 including the delete button 5237 itself.

The cases of deleting the display of one row displayed in the purchase presumption information display area 523 include the case a person is not imaged in the presumption target data played back by the play button 5231, the case where another person who is not a specified customer is imaged, the case where one behavior is captured in duplicate, the case where the customer not doing anything (acquisition behavior or checkout behavior is not performed) is imaged, and the like. These are cases where the processing of generating presumption target data from the imaging data of the camera 10 executed by the behavior analysis device 30 is not properly performed. Therefore, if the presumption target data generation processing in the behavior analysis device 30 is also performed by using the machine learning model, if the data related to the behavior deleted from the purchase presumption information display area 523 is output to the behavior analysis device 30 as training data for the presumption target data generation processing, the accuracy of the presumption target data generation processing can be improved.

The item addition button 5238 is a button for the operator to manually add an item. The OK button 5239 is a button for storing the corrected behavior information. The corrected data may be automatically stored if the corrected content is input (for example, if a pop-up display where the corrected content can be input is closed), and in this case, the OK button 5239 is unnecessary.

In the transaction information display area 524, a corresponding receipt information display section 5241 is displayed. The corresponding receipt information display section 5241 displays the commodity name and quantity of the commodity included in the transaction information checked out at the POS terminal 20 for one transaction corresponding to the information for one transaction displayed in the purchase presumption information display area 523.

The correction of the behavior information using the correction screen 521 will be described. First, as described above, if there is a mismatch in the comparison results of the comparison unit 5005, the correction screen 521 is displayed. That is, if the commodity (including the quantity) presumed to have been purchased by the customer by the behavior analysis device 30 and the commodity (including the quantity) checked out at the POS terminal 20 do not match for one transaction specified by the transaction specific information, the correction screen 521 is displayed.

In the example of FIG. 9, the commodities included in the purchase presumption information output by the behavior analysis device 30 are the commodity A, the commodity B, and the commodity C, whereas the commodities included in the transaction information output by the POS terminal 20 are the commodity A and the commodity C.

In the purchase presumption information display area 523, the behavior information that is the basis for presuming that the commodity A, the commodity B, and the commodity C have been purchased by the behavior analysis device 30 is displayed. The behavior analysis device 30 presumes that the commodity A has been purchased based on the machine learning model presuming an acquisition behavior for the commodity A (see the first row of the determined behavior information display section 5233). Similarly, the behavior analysis device 30 presumes that the commodity B has been purchased based on the machine learning model presuming an acquisition behavior for the commodity B (see the second row of the determined behavior information display section 5233).

For the commodity C, the behavior analysis device 30 generates two pieces of presumption target data, and a behavior is determined by the machine learning model. Specifically, for the commodity C, the acquisition behavior is not presumed by the machine learning model in one piece (see the third row of the determined behavior information display section 5233), and the acquisition behavior is presumed in the other piece (see the fifth row of the determined behavior information display section 5233). Based on the presumption result of this machine learning model, the behavior analysis device 30 presumes that the commodity C has been purchased. The information displayed in the third row of the determined behavior information display section 5233 is the behavior of the customer extracted based on the sensor information, which is an example of information indicating a behavior that is not presumed to have been performed by the customer.

For a commodity D, the behavior analysis device 30 generates two pieces of presumption target data, and a behavior is determined by the machine learning model. Specifically, for the commodity D, the acquisition behavior is presumed by the machine learning model in one piece (see the fourth row of the determined behavior information display section 5233), and the return behavior is presumed in the other piece (see the sixth row of the determined behavior information display section 5233). Based on the presumption result of this machine learning model, the behavior analysis device 30 presumes that the commodity D was taken out from the commodity display shelf by the customer, but returned to the commodity display shelf and not purchased by the customer.

The operator who operates the information processing device 50 corrects the behavior information related to the commodity B which is included in the purchase presumption information output by the behavior analysis device 30 but is not included in the transaction information output by the POS terminal 20. In the correction, the operator operates the play button 5231 in the second row corresponding to the behavior information related to the commodity B, and visually confirms the presumption target data displayed on the display frame 5221. As a result of visually confirming the presumption target data, the operator confirms that the commodity B has not been acquired from the commodity display shelf by the customer, and then operates the correction button 5236 in the second row to correct the determination result of the acquisition behavior from “O” to “X”. In this way, the behavior information is corrected.

The information processing device 50 may automatically correct the behavior information without displaying the correction screen. For example, in the example illustrated in FIG. 9, since there is only one behavior information regarding the commodity B that is included in the purchase presumption information but is not included in the transaction information, this behavior information can be automatically corrected. Further, for example, if the quantity of the commodity B presumed to have been purchased in the purchase presumption information is two, while the quantity of the commodity B included in the transaction information is one, the behavior information with a low probability value may be automatically corrected from “O” to “X” as an error.

However, as in the present embodiment, accurate corrected data can be provided to the behavior analysis device 30 by displaying the correction screen, confirming by the operator, and correcting the behavior information. This is because even if the commodity is taken out from the commodity display shelf by the customer, the commodity may not be checked out due to shoplifting by the customer or forgetting to register the commodity by the clerk. Since the correction screen is displayed only if the commodity name and quantity of the commodity included in the purchase presumption information do not match the commodity name and quantity of the commodity included in the transaction information, the workload on the operator will not be greater than necessary.

As described above, the information processing device 50 of the embodiment includes the purchase presumption information acquisition unit 5001 that acquires purchase presumption information in which behavior information indicating a behavior of a customer presumed based on sensor information of a sensor installed in a store, commodity identification information identifying a commodity that a customer is presumed to have purchased in one transaction based on the behavior information, and transaction specific information specifying the one transaction are associated with each other, the transaction information acquisition unit 5003 that acquires transaction information that is information related to the transaction of the store, in which the commodity identification information of a commodity traded in one transaction is associated with the transaction specific information, the comparison unit 5005 that compares the commodity identification information included in the purchase presumption information with the commodity identification information included in the transaction information with respect to one transaction specified by the transaction specific information, the correction unit 5006 that corrects the behavior information based on the transaction information if the commodity identification information included in the purchase presumption information and the commodity identification information included in the transaction information do not match as a result of the comparison by the comparison unit 5005, and the output unit 5009 that outputs the behavior information corrected by the correction unit 5006.

As a result, the transaction information can be utilized to correct the behavior information presumed by the machine learning model, and the corrected behavior information can be provided to the machine learning model as training data. Therefore, it is possible to easily improve the determination accuracy of the machine learning model that presumes the behavior of the customer in the store.

Further, in the information processing device 50 of the embodiment, the purchase presumption information acquisition unit 5001 acquires behavior information indicating the behavior of the customer extracted based on the sensor information and not presumed to have been performed by the customer.

As a result, it is possible to correct the behavior information indicating the behavior that the machine learning model did not presume, in other words, the behavior that the machine learning model determined was not performed. Therefore, since the information processing device 50 can provide more corrected behavior information to the machine learning model, the determination accuracy of the machine learning model can be further improved.

Further, the information processing device 50 of the embodiment further includes the imaging data acquisition unit 5002 that acquires imaging data as sensor information which is the imaging data of the camera 10, the display processing unit 5007 that displays the imaging data acquired by the imaging data acquisition unit 5002 on the display device 520, and the reception unit 5008 that accepts input for correction of behavior information.

As a result, the operator who operates the information processing device 50 can correct the behavior information after confirming the imaging data in which the behavior of the customer is imaged. Therefore, the behavior information can be corrected more accurately.

In addition, in the information processing device 50 of the embodiment, the display processing unit 5007 displays imaging data acquired by the imaging data acquisition unit 5002, behavior information and commodity identification information acquired by the purchase presumption information acquisition unit 5001, and a correction screen for displaying commodity identification information acquired by the transaction information acquisition unit 5003 on the display device for one transaction specified by the transaction specific information.

As a result, it is possible to improve the operability of the operator who corrects the behavior information. Therefore, it is possible to reduce the load on the operator.

In the above embodiment, the control program executed by the behavior analysis device 30, the store server 40, and the information processing device 50 may be recorded on a computer-readable recording medium such as a CD-ROM and provided. Further, the control program executed by each of the above-described devices of the above-described embodiment may be stored on a computer connected to a network such as the Internet and provided by downloading via the network, and further may be provided via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a communications interface configured to facilitate communication with a server and a behavior analysis device; and
a processing circuit configured to:
acquire purchase presumption information from the server, the purchase presumption information including behavior information indicating a behavior of one or more customers presumed based on sensor information acquired by a sensor installed in a store, first commodity identification information identifying one or more commodities that the one or more customers are presumed to have purchased in presumed transactions based on the behavior information, and first transaction specific information specifying each of the presumed transactions, the purchase presumption information generated by the behavior analysis device;
acquire transaction information from the server, the transaction information related to completed transactions performed within the store via a point of sale system, the transaction information including second commodity identification information identifying one or more commodities purchased in each of the completed transactions and second transaction specific information specifying each of the completed transactions;
compare the first commodity identification information included in the purchase presumption information with the second commodity identification information included in the transaction information with respect to a respective transaction specified by the first transaction specific information and the second transaction specific information;
generate corrected behavior information for the respective transaction based on the transaction information in response to the first commodity identification information included in the purchase presumption information and the second commodity identification information included in the transaction information not matching; and
transmit the corrected behavior information to the behavior analysis device.

2. The information processing device of claim 1, wherein the purchase presumption information and the transaction information are acquired for a period of time including a plurality of presumed transactions and a plurality of completed transactions, respectively.

3. The information processing device of claim 1, wherein the period is a month.

4. The information processing device of claim 1, wherein the behavior of the one or more customers extracted based on the sensor information includes a presumption that a commodity was acquired from a shelf, returned to the shelf, or purchased.

5. The information processing device of claim 1, wherein the sensor is a camera, wherein the sensor information is imaging data of the camera, and wherein the processing circuit is configured to:
acquire the imaging data from the server;
display the imaging data on a display device;
receive a correction input for the behavior information; and
generate the corrected behavior information based on the correction input.

6. The information processing device of claim 5, wherein the processing circuit is configured to display a correction screen in response to the first commodity identification information not matching the second commodity identification information, the correction screen including the imaging data, the behavior information, the first commodity identification information, and the corrected behavior information.

7. The information processing device of claim 6, wherein the imaging data is a user selectable and playable video.

8. A method for causing a computer to control an information processing device, the method comprising:
acquiring, by a processing circuit from a server, purchase presumption information including behavior information indicating a behavior of one or more customers presumed based on sensor information acquired by a sensor installed in a store, first commodity identification information identifying one or more commodities that the one or more customers are presumed to have purchased in presumed transactions based on the behavior information, and first transaction specific information specifying each of the presumed transactions, the purchase presumption information generated by a behavior analysis device;
acquiring, by the processing circuit from the server, transaction information related to completed transactions performed within the store via a point of sale system, the transaction information including second commodity identification information identifying one or more commodities purchased in each of the completed transactions and second transaction specific information specifying each of the completed transactions;
comparing, by the processing circuit, the first commodity identification information included in the purchase presumption information with the second commodity identification information included in the transaction information with respect to a respective transaction specified by the first transaction specific information and the second transaction specific information;
generating, by the processing circuit, corrected behavior information for the respective transaction based on the transaction information in response to the first commodity identification information included in the purchase presumption information and the second commodity identification information included in the transaction information not matching; and
transmitting, by the processing circuit, the corrected behavior information to the behavior analysis device.

9. The method of claim 8, wherein the purchase presumption information and the transaction information are acquired for a period of time including a plurality of presumed transactions and a plurality of completed transactions, respectively.

10. The method of claim 9, wherein the period is a month.

11. The method of claim 8, wherein the sensor is a camera, wherein the sensor information is imaging data of the camera, further comprising:
acquiring, by the processing circuit, the imaging data from the server;
displaying, by the processing circuit, the imaging data on a display device;
receiving, by the processing circuit, a correction input for the behavior information; and
generating, by the processing circuit, the corrected behavior information based on the correction input.

12. The method of claim 11, further comprising displaying, by the processing circuit on the display device, a correction screen in response to the first commodity identification information not matching the second commodity identification information, the correction screen including the imaging data, the behavior information, the first commodity identification information, and the corrected behavior information.

13. The method of claim 12, wherein the imaging data is a user selectable and playable video.

14. The method of claim 8, wherein the behavior of the one or more customers extracted based on the sensor information includes a presumption that a commodity was acquired from a shelf, returned to the shelf, or purchased.

15. A behavior analysis system comprising:
a behavior analysis device configured to presume a behavior of customers in a store;
a checkout device configured to execute checkout processing for transactions in the store; and
an information processing device configured to correct information indicating the behavior of the customers presumed by the behavior analysis device based on transaction information of the transactions performed by the checkout device, wherein, to correct the information, the information processing device configured to:
acquire purchase presumption information generated by the behavior analysis device, the purchase presumption information including behavior information indicating a behavior of one or more customers presumed based on sensor information acquired by a sensor installed in a store, first commodity identification information identifying one or more commodities that the one or more customers are presumed to have purchased in presumed transactions based on the behavior information, and first transaction specific information specifying each of the presumed transactions;
acquire the transaction information generated by the checkout device related to the transactions performed within the store via the checkout device, the transaction information including second commodity identification information identifying one or more commodities purchased in each of the transactions and second transaction specific information specifying each of the transactions;
compare the first commodity identification information included in the purchase presumption information with the second commodity identification information included in the transaction information with respect to a respective transaction specified by the first transaction specific information and the second transaction specific information;
generate corrected behavior information for the respective transaction based on the transaction information in response to the first commodity identification information included in the purchase presumption information and the second commodity identification information included in the transaction information not matching; and
transmit the corrected behavior information to the behavior analysis device.
